(19) United States
(12) Patent Application Publication
(10) Pub. No.: US 2008/0074969 A1
(43) Pub. Date: Mar. 27, 2008

(54) Recording Condition Optimizing Method, Information Recording/Reproducing Device, And Integrated Circuit Device

(76) Inventors: Harumitsu Miyashita, Nara (JP); Yasumori Hino, Nara (JP); Tetsuya Shihara, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/631,937

(22) PCT Filed: Jun. 23, 2005
(86) PCT No.: PCT/JP05/11516

§ 371 Date: Jan. 9, 2007

(30) Foreign Application Priority Data
Jul. 12, 2004 (JP) 2004-205251

(51) Int. Cl. G11B 15/52

(52) U.S. Cl. 369/47.53

(57) ABSTRACT

It is an object to minimize the effect of the reproduction transmission path characteristics or optical characteristics of an optical head, and more suitably adjust recording conditions. The recording condition optimization method of the present invention involves optimizing recording conditions in the recording of information to an optical disk (100), comprising a recording step (1103) of recording a recording pattern including a plurality of recording marks to the optical disk using specific recording conditions, a reproduction step (1102) of reproducing the recording pattern recorded in the recording step (1103), an equalization characteristics setting step (1101) of setting waveform equalization characteristics according to the recording pattern, an equalization step (1105) of using the waveform equalization characteristics set in the equalization characteristics setting step (1101) to equalize the waveform of the reproduction signal reproduced in the reproduction step (1102), and an adjustment step (1104) of using the reproduction signal whose waveform has been equalized in the equalization step (1105) to adjust the recording conditions.

### TECHNICAL FIELD

The present invention relates to a recording condition optimization method, an information recording and reproduction apparatus, and an integrated circuit apparatus for optically recording and reproducing information by utilizing a light beam from a light source such as a semiconductor laser.

### BACKGROUND ART

The increasing popularity of personal computers has led to the widespread use of information recording devices for recording digital information, such as optical disk devices, hard disk devices (HDD), and opto-magnetic disk devices. A great deal of technological development aimed at raising density in these information recording devices is underway in order to increase recording capacity.

Particularly in optical disk devices, which make use of an optical disk as an information medium, higher-density recording has been achieved in the change from CD to DVD. Also, we are now seeing the debut of the BD (Blu-ray Disc), which makes use of a blue laser and has a capacity of 23 gigabytes. Further, the debut of a device in which higher-density recording is achieved is expected in the future.

In recording tiny marks with light on a high-density information medium of this sort, the laser that irradiates the optical disk (information medium) is subjected to pulse modulation. Then, in performing mark edge recording in which there is information in the mark edges, the recording is generally performed by correcting the recording pulse used for accurately aligning the mark edges. A recording conditions correction method such as this has already been proposed (see Patent Document 1, for example).

A conventional method for examining (adjusting) recording conditions will now be described through reference to FIG. 10.

FIG. 10 is a block diagram of the configuration of a conventional optical disk device.

An optical disk device has an optical head 101 that records and reproduces information to and from an optical disk 100, a pre-amplifier 105 for amplifying the output of the optical head 101, a motor 112 for rotating the optical disk 100, a waveform equalization circuit 106 for equalizing the waveform of a reproduction signal, a binarization circuit 108 for binarizing the waveform equalized signal, a PLL circuit 109 for extracting a clock signal from the binarized data, a discriminating demodulation circuit 110 for subjecting the binarized reproduction data to discriminating demodulation, a modulation circuit 104 for modulating a data string into modulated data as a recording pulse string for recording recording data to the optical disk 100, a recording pulse setting circuit 103 for setting recording pulses according to the modulated data, and a laser drive circuit 102 for driving a laser according to the set recording pulses. The optical disk device is further equipped with a random access memory for storing recording pulse values ahead of time, and has a system controller 111 for controlling the device.

With this configuration, when recording pulses are adjusted for recording to the optical disk 100, the desired identification data (recording pattern) is first recorded on the optical disk 100, and this recorded signal is reproduced. Since the prerecorded identification data is already known, a decision can be made as to whether or not the reproduced data matches the recorded identification data. If the prerecorded identification data should be different from the reproduced data, the recording pulses are corrected, the identification data is recorded once again, and the recorded data is reproduced. A method has been proposed in which a recording pulse examination is continued until the reproduced data matches the prerecorded identification data.

Patent Document 1: Japanese Patent No. 3,222,934

### DISCLOSURE OF THE INVENTION

### Problems Which the Invention is Intended to Solve

With a conventional information recording apparatus configured as above, the following problem needs to be solved in order that density should be raised any further. Because of the effect of waveform distortion of the reproduction transmission path, the proper marks cannot always be recorded on an optical disk merely by adjusting the recording conditions using a reproduction signal. The reason for this is that variance in the focusing of the beam emitted from the optical head changes the optical characteristics, and as a result waveform distortion appears in the reproduction signal.

The present invention was conceived in light of the above problem, and it is an object thereof to minimize the effect of the reproduction transmission path characteristics and optical characteristics of an optical head, and more suitably adjust recording conditions.

### Means Used to Solve the Above-Mentioned Problems

To solve the above-mentioned problems encountered in the past, the method for optimizing a recording condition according to the present invention is a method for optimizing recording conditions in recording of information to an optical disk, comprising a recording step of recording a recording pattern including a plurality of recording marks to the optical disk using a specific recording condition, a reproduction step of reproducing the recording pattern recorded in the recording step, an equalization characteristics setting step of setting waveform equalization characteristics according to the recording pattern, an equalization step of using the waveform equalization characteristics set in the equalization characteristics setting step to equalize a waveform of a reproduction signal reproduced in the reproduction step, and an adjustment step of using the reproduction signal whose waveform has been equalized in the equalization step to adjust the recording condition. This achieves the stated object.

Here, for example, the recording pattern is preset in order to adjust the recording condition, and includes a plurality of recording marks. More specifically, the recording pattern may include recording marks of a plurality of recording mark lengths. In the equalization step, the waveform equalization is performed using waveform equalization characteristics corresponding to the recording pattern. Further, in the adjustment step, the reproduction signal whose waveform has been appropriately equalized is used to adjust the recording condition.

When the reproduction signal is used to adjust the recording condition, there are times when the reproduction signal that is supposed to serve as a reference is affected by the reproduction transmission path characteristics or optical characteristics of the optical head. With the recording condition optimization method of the present invention, the recording condition is adjusted by setting appropriate waveform equalization characteristics for the reproduction signal and using a signal obtained by the waveform equalization. This allows more suitable adjustment of the recording condition.

A plurality of recording patterns may be provided, and the recording condition may be adjusted for each of these recording patterns.

Also, the recording condition here is a condition pertaining to modulated pulses in the recording of information to the optical disk. This achieves the stated object.

Also, the position of the modulated pulse is adjusted in the adjustment step. Adjusting the position of the modulated pulse makes it possible to change the modulated pulse width, for example. This achieves the stated object.

Also, at least one of the recording patterns does not include a shortest mark. This achieves the stated object.

Here, the shortest mark refers to a recording mark having the shortest recording mark length of all the recording marks recorded as information to the optical disk (the same applies hereinafter). For instance, in the recording of information, when a recording mark having a length of from 2T to 8T is used (more specifically, when a (1, 7) RLL code is used, for example), the shortest mark refers to a 2T recording mark. Information recording refers, for example, to the recording of user data.

Also, at least one of the recording patterns includes a shortest mark. This achieves the stated object.

Also, a high-band gain of the waveform equalization characteristics in the recording and reproduction of the recording pattern including no shortest mark is lower than a high-band gain of the waveform equalization characteristics in the recording and reproduction of the recording pattern including a shortest mark. This achieves the stated object.

Also, the recording marks in the recording pattern are generated substantially uniformly. In general, when user data is recorded, recording marks of short recording mark lengths are generated more frequently, and recording marks of long recording mark lengths are generated less frequently. With the recording pattern used in the present invention, the incidence at which recording marks of short recording mark lengths are generated is made lower, and the incidence at which recording marks of long recording mark lengths are generated is made higher, than when user data is recorded. This achieves the stated object.

Also, the waveform equalization characteristics are characteristics determined by reproducing a portion where a desired signal has been recorded or formed on the disk ahead of time. This achieves the stated object.

Also, the adjustment step includes a step of detecting phase error information of the reproduction signal, and modulated pulses are adjusted on the basis of the phase error information so that the phase error information becomes smaller overall. This achieves the stated object.

To solve the above-mentioned problem encountered in the past, the information recording and reproduction apparatus of the present invention is an apparatus for recording and reproducing information to and from an optical disk using a light source such as a laser, comprising a recording unit for recording a recording pattern including a plurality of recording marks to the optical disk using a specific recording condition, a reproduction unit for reproducing the recording pattern recorded by the recording unit, an equalization characteristics setting unit for setting waveform equalization characteristics according to the recording pattern, an equalization unit for using the waveform equalization characteristics set by the equalization characteristics setting unit to equalize a waveform of a reproduction signal reproduced in the reproduction unit, and an adjustment unit for using the reproduction signal whose waveform has been equalized in the equalization unit to adjust the recording condition.

Here, the recording unit may, for example, have a laser drive pulse modulation unit for modulating a light source, and recording execution unit for recording two or more specific recording patterns. This achieves the stated object.

Also, the equalization characteristics setting unit varies the waveform equalization characteristics on the basis of characteristics determined by reproducing a portion where a desired signal has been recorded or formed on the disk ahead of time. This achieves the stated object.

A gain of the waveform equalization characteristics in the reproduction of the recording pattern that does not include a shortest mark is lower than a gain of the waveform equalization characteristics in the reproduction of the recording pattern that includes a shortest mark. This achieves the stated object.

To solve the above-mentioned problem encountered in the past, the integrated circuit apparatus of the present invention is an apparatus for optimizing a recording condition in the recording of information to an optical disk, comprising an equalization characteristics setting component for setting the waveform equalization characteristics according to a recording pattern that is recorded to the optical disk using a specific recording condition and includes a plurality of recording marks, and an adjustment component for adjusting the recording condition by using a signal obtained by equalizing, with the waveform equalization characteristics, a waveform of a reproduction signal obtained by reproducing the recording pattern recorded to the optical disk. This achieves the stated object.

### EFFECT OF THE INVENTION

As discussed above, with the present invention, the waveform equalization characteristics are switched in the course of adjusting a recording condition, which makes it possible to record signals at higher reliability. Specifically, the effect of reproduction transmission path characteristics is minimized, allowing more uniform recording marks to be formed. Additionally, the allowable range of variance for the optical head and other such elements can be expanded, making it possible to provide an optical disk device at lower cost.

### BRIEF DESCRIPTION OF THE DRAWINGS

FIG. 1 is a schematic diagram of the functional configuration of the recording modulated pulse adjustment method in an embodiment of the present invention;

FIG. 2 is a block diagram of the configuration of the optical disk device in an embodiment of the present invention;

FIG. 3 is a time chart of a PLL clock signal and a reproduction signal in an embodiment of the present invention;

FIG. 4 is a time chart of a recording pulse with respect to a recording clock signal in an embodiment of the present invention;

FIG. 5 is a table giving a parameter list of recording pulses during recording in an embodiment of the present invention;

FIG. 6 is a schematic diagram of the recording region for adjusting the recording modulated pulse in an embodiment of the present invention;

FIG. 7 is a graph of the phase error detection result in the reproduction of recording regions in which a recording modulated pulse region is adjusted in an embodiment of the present invention;

FIG. 8 is a flowchart of a recording modulated pulse adjustment method using two different recording patterns in an embodiment of the present invention;

FIG. 9 is a graph of the gain characteristics of a waveform equalization circuit in an embodiment of the present invention;

FIG. 10 is a block diagram of the configuration of a conventional optical disk; and

FIG. 11 is a flowchart illustrating the operation of the information recording and reproduction apparatus in an embodiment of the present invention.

### REFERENCE NUMERALS

100 disk
1101 waveform equalization characteristics setting step
1102 reproduction step
1103 recording step
1104 adjustment step
1105 equalization step
1000 optical disk device

### BEST MODE FOR CARRYING OUT THE INVENTION

An embodiment of the present invention will now be described through reference to the drawings. In the drawings, those members having the same function are given the same reference numbers.

With the information recording and reproduction apparatus of the present invention, the recording conditions are examined in the recording of information to an optical disk (recording modulated pulse conditions). More specifically, the information recording and reproduction apparatus records specific recording marks, reproduces the recorded recording marks, and examines recording conditions using the reproduced reproduction signal. In this examination of recording conditions, the waveform of the reproduction signal is equalized using waveform equalization characteristics determined according to specific recording marks. That is, switching the waveform equalization characteristics makes it possible to record signals of higher reliability, and allows more uniform recording marks to be formed.

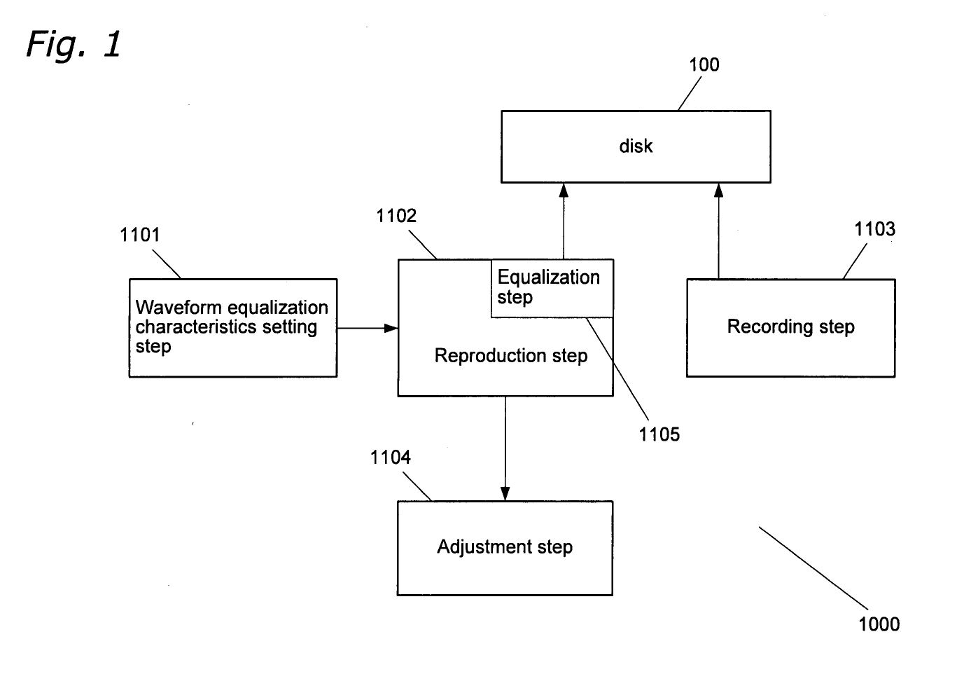

FIG. 1 shows the functional configuration of the information recording and reproduction apparatus 1000 pertaining to the present invention. The information recording and reproduction apparatus 1000 comprises a recording step 1103 of recording data to an optical disk 100, a reproduction step 1102 of reproducing the information on the optical disk 100, an equalization step 1105 of performing waveform equalization in the reproduction of information on the optical disk 100, an equalization characteristics setting step 1101 of setting waveform equalization characteristics, and an adjustment step 1104 of using the detected information obtained in the reproduction step 1102 to examine the optimal recording conditions.

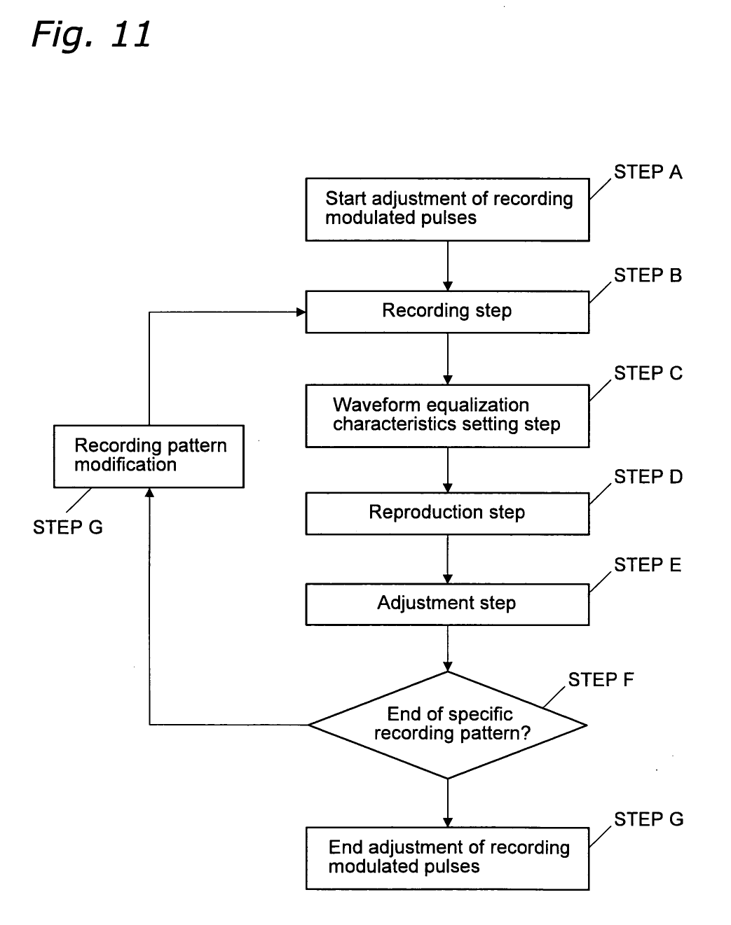

FIG. 11 is a flowchart illustrating the operation of the information recording and reproduction apparatus 1000. First, the information recording and reproduction apparatus 1000 starts the adjustment of the recording modulated pulse (step A), and in the recording step 1103 a specific recording pattern is recorded on the optical disk 100 (step B). Next, the waveform equalization characteristics are set in the reproduction of the recorded data (step C). In this setting of waveform equalization characteristics, the waveform equalization characteristics setting step 1101 involves setting the waveform equalization characteristics according to the recording pattern. Next, a reproduction step 1102 is executed, in which a clock signal is extracted from the reproduction signal, and reproduction signal information, such as phase information, is detected (step D). Next, in the adjustment step 1104, the conditions of the recording modulated pulse are adjusted on the basis of the result obtained in the reproduction step 1102 (step E). With the recording modulated pulse adjustment in this embodiment, a plurality of recording patterns are recorded. Accordingly, when there is a recording pattern that has not been recorded (step F), the recording pattern is changed (step G) and the process from the recording step 1103 (step B) to the adjustment step 1104 (step E) is repeated. Once all of the specified recording patterns have been recorded (step F), the recording modulated pulse adjustment is concluded (step H).

A method for controlling an optical disk device including the recording modulated pulse adjustment method pertaining to an embodiment of the present invention will now be described in detail.

Although not shown in FIG. 11 for the sake of simplicity, the information recording and reproduction apparatus 1000 of the present invention comprises, in addition to the components described above, the components necessary for the recording and reproduction of information and the rotation of the disk.

Any conventional components can be employed for those components not described in this specification (see Patent Document 1, for example).

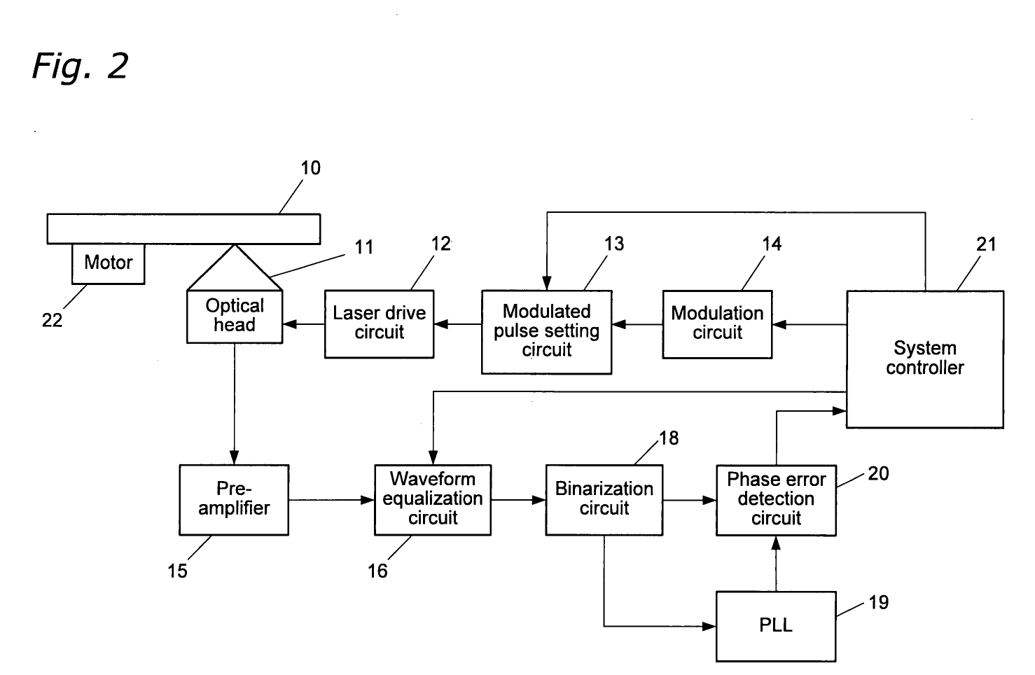

FIG. 2 is a block diagram of an optical disk device (information recording and reproduction apparatus) as an embodiment of the present invention.

To make it easier to understand, the following description will assume that the recording pattern is a (1, 7) RLL (Run Length Limited) code, and that there are two recording patterns used for adjustment. With this code, if we let T be the unit clock period, the recording mark length of the shortest mark is 2T, and the recording mark length of the longest mark is 8T.

In FIG. 2, the optical disk device reproduces information on an optical disk 10, and has an optical head 11 for recording and reproducing information to and from the optical disk 10, a pre-amplifier 15 for amplifying the output of the optical head 11, a motor 22 for rotating the optical disk 10, a waveform equalization circuit 16 for equalizing the waveform of a reproduction signal, a binarization circuit 18 for binarizing the signal whose waveform has been equalized, a PLL circuit 19 for extracting a clock signal from the binarized data, and a phase error detection circuit 20 for detecting the phase error in binarized reproduction data.

The optical disk device also records information to the optical disk 10, and has a modulation circuit 14 for modulating a data string into modulated data (a recording pulse string) for recording data to the optical disk 10, a modulated pulse setting circuit 13 for setting recording pulses according to the modulated data, and a laser drive circuit 12 for driving a laser according to the set recording pulses.

In addition, the optical disk device has a random access memory for storing modulated pulse settings ahead of time, and a system controller 21 for controlling the entire device.

The “recording unit” is made up of the modulation circuit 14, the modulated pulse setting circuit 13, the laser drive circuit 12, and the optical head 11. The “reproduction unit” is made up of the optical head 11 and the pre-amplifier 15. The “equalization characteristics setting unit” or “equalization characteristics setting component” is made up of the system controller 21. The “equalization unit” is made up of the waveform equalization circuit 16. The “adjustment unit” or “adjustment component” is made up of the system controller 21.

Tracking and focus control for the recording and reproduction of information may be accomplished by standard methods.

First, the waveform equalization characteristics of the waveform equalization circuit 16, and the method for setting these waveform equalization characteristics, in the present invention will be described.

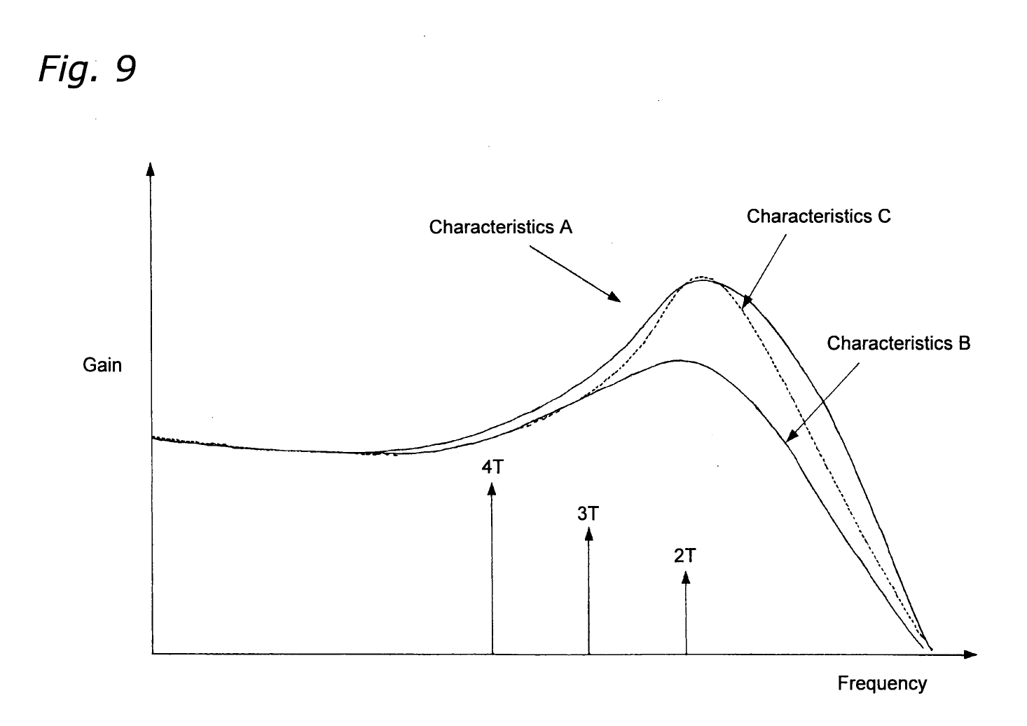

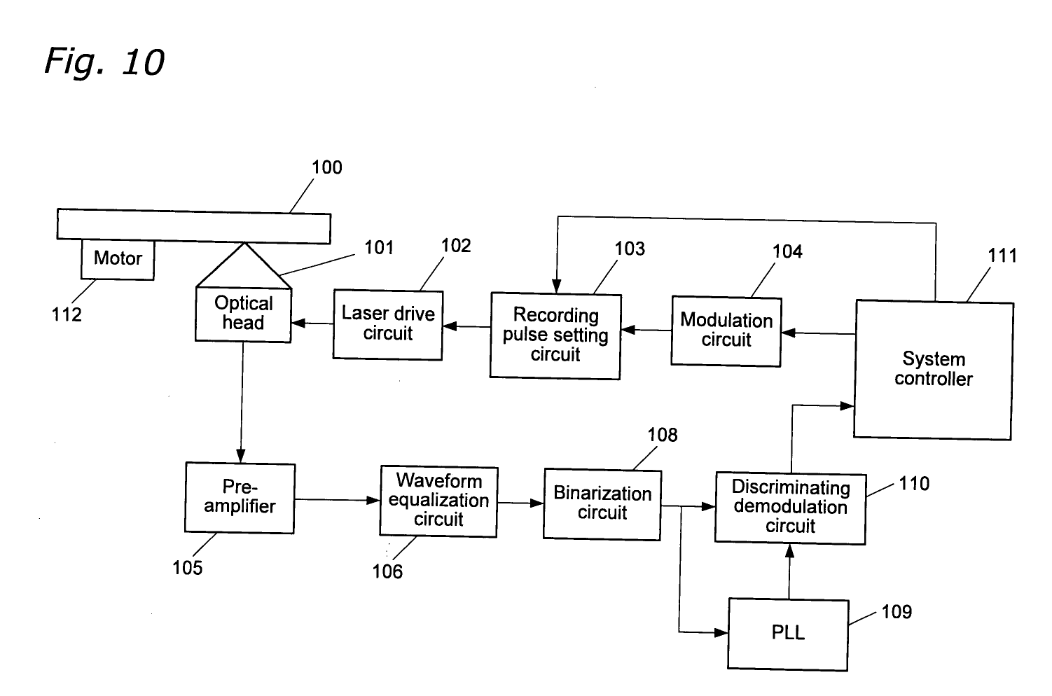

FIG. 9 shows the gain characteristics of the waveform equalization circuit 16. The horizontal axis is the frequency, and the vertical axis is the gain. Of the various frequencies corresponding to the recording marks, the 2T, 3T, and 4T frequency positions are schematically illustrated. The characteristics must be such that the gain is higher in the high band in order to increase the gain with respect to short recording marks. To switch the gain characteristics between the characteristics A and B shown in FIG. 9, a digital value is set for the waveform equalization circuit 16 from the system controller 21, or a voltage value or current value is set.

The characteristics C shown in FIG. 9 indicate the optimal waveform equalization characteristics when reproducing information from a suitably recorded disk. More specifically, they indicate the optimal waveform equalization characteristics when reproducing a portion where the desired signal has been recorded or formed on the disk ahead of time. Even more specifically, we will let the characteristics C be the optimal waveform equalization characteristics when reproducing information from a suitably recorded disk in which there is extremely little variance in the recording mark lengths and mark edges, such as when the variance in the recording mark length is no more than 2% with respect to the reference clock signal length, and the variance in the mark edges is no more than 5% with respect to the reference clock signal length. In this case, variance in the optical head and so forth causes the characteristics of the reproduction signal to have smooth or sharp gain characteristics, and the characteristics C are put in a state not suitable for a reproduction signal obtained by reproducing a signal obtained from recorded recording marks with a recording mark length of 2T or 3T.

In view of this, when the recording conditions are adjusted by reproducing a recording pattern that does not include 2T (the shortest mark), recording modulated pulse adjustment is performed with the characteristics B set as the waveform equalization characteristics. Then, when the recording conditions are adjusted by reproducing a recording pattern that does include 2T, recording modulated pulse adjustment is performed with the characteristics A set as the waveform equalization characteristics. Adjusting the recording conditions as above by switching the waveform equalization characteristics according to the recording pattern makes it possible to achieve the same waveform equalization characteristics as with the characteristics C, for any of the recording marks. The characteristics A are determined such that the gain will be higher at a specific frequency (specifically, the frequency corresponding to the 2T recording mark) than with the characteristics B.

The waveform equalization characteristics A and the waveform equalization characteristics B used for achieving the waveform equalization characteristics C are obtained by storing a waveform equalization characteristics setting value (characteristics C) for reproducing information from a disk to which an ideal signal has been recorded ahead of time, in the system controller 21 or another such information recording device, and varying the characteristics C according to the recording pattern being used during the recording modulated pulse adjustment of the device. If the recording patterns to be used are determined ahead of time, then the waveform equalization characteristics corresponding to each of the recording patterns (such as the characteristics A and B) may be stored in the device ahead of time. In this case, the waveform equalization characteristics corresponding to the recording patterns are set as the waveform equalization characteristics for reproduction.

The waveform equalization circuit 16 is made up of an ordinary low-pass filter or high-pass filter, and any type can be used as long as it affords gain characteristics such that the frequency band (and particularly a high frequency region) corresponding to the code will be raised up as shown in FIG. 9.

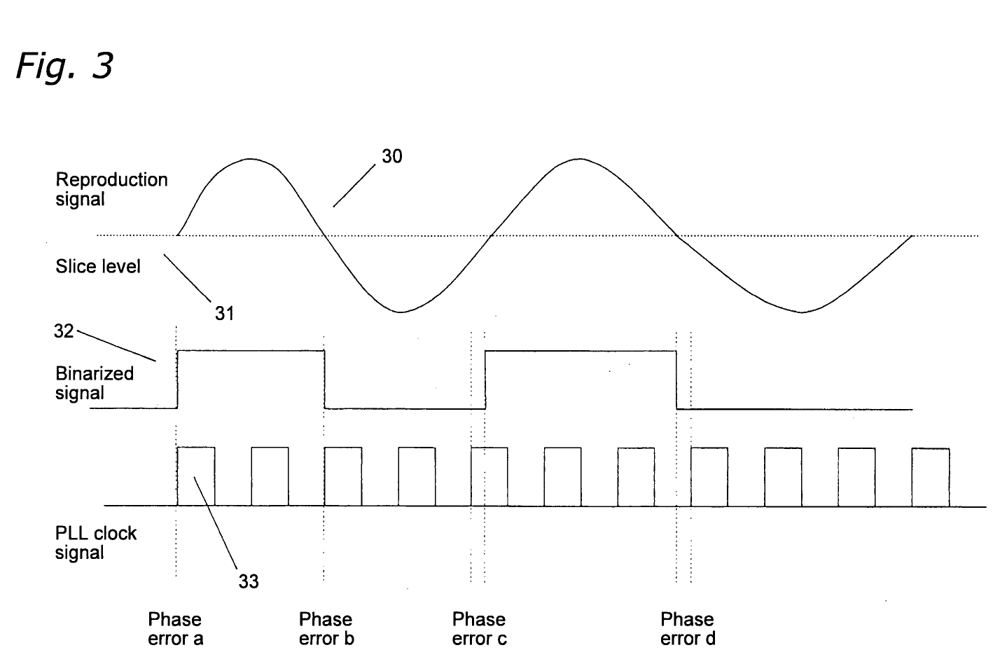

Next, the method for detecting phase error information from a waveform equalized reproduction signal in the present invention will now be described through reference to FIG. 3.

FIG. 3 is a time chart of a reproduction signal and a PLL clock signal.

FIG. 3 shows a reproduction signal 30, a binarized signal 32 that is the output signal of the binarization circuit 18, and a slice level 31 for binarizing the reproduction signal 30. The binarized signal 32 outputs a 1 if the reproduction signal 30 is above the slice level 31, and a 0 if the reproduction signal 30 is below the slice level 31. The PLL circuit 19 constitutes a PLL loop, and uses the phase error between a PLL clock signal 33 and the binarized signal 32 in the course of synchronizing the clock signal to the binarized signal 32. This phase error is detected as follows. If the recorded signal or recording mark is of the proper length, the leading and trailing edge positions of the binarized signal 32 coincide with the edge positions of the PLL clock signal 33, as shown by phase error a and phase error b. In contrast, if the recorded signal or recording mark is shorter than the proper length, for example, there will be deviation between the binarized signal 32 and the PLL clock signal 33, as shown by the phase error c and the phase error d. The amount of this phase error is detected as voltage information or a digital value.

The relation between waveform equalization characteristics and this binarized signal 32 will now be described. If the gain of the waveform equalization characteristics is high, the reproduction signal 30 will be larger, so the binarized signal 32 will be longer. Conversely, if the gain of the waveform equalization characteristics is low, the reproduction signal 30 will be smaller, so the binarized signal 32 will be shorter. This difference in waveform equalization characteristics, as well as variance in the optical head, changes in the reproduction transmission path characteristics, and so forth can be detected as phase error.

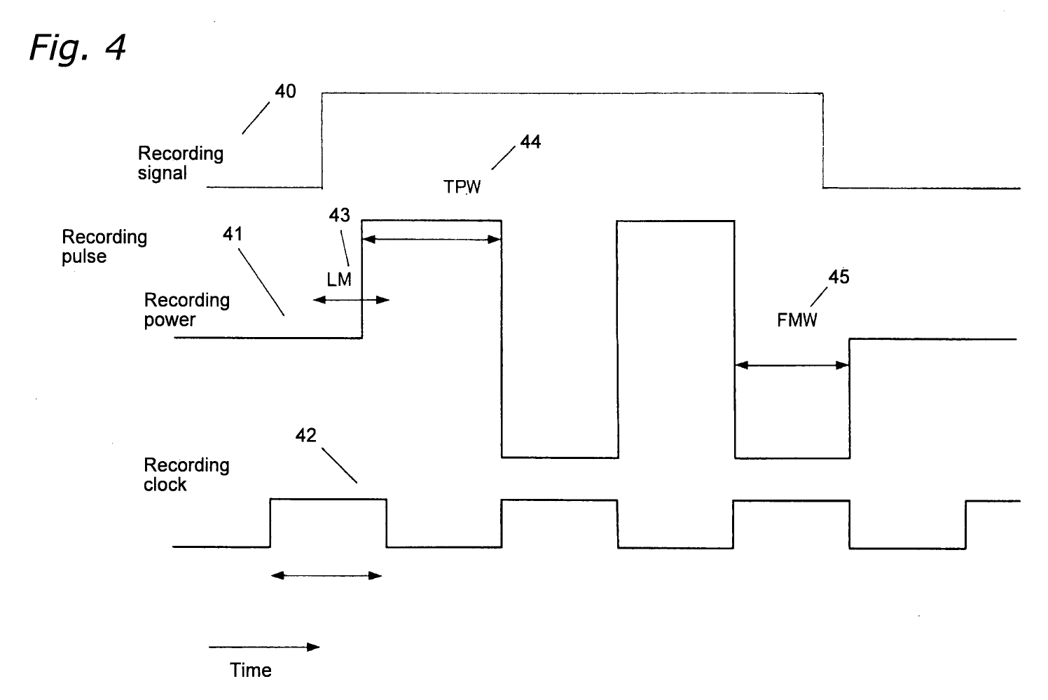

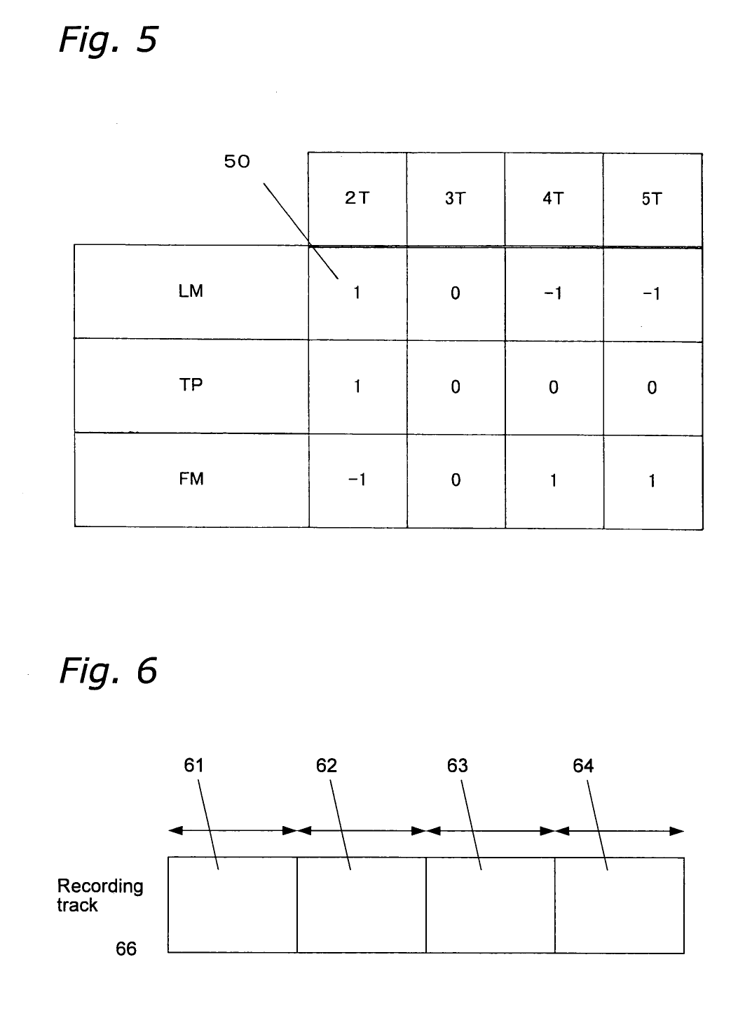

Next, the recording modulated pulse used during recording in the present invention will be described through reference to FIGS. 4 and 5.

FIG. 4 is a time chart of a recording pulse with respect to a recording clock signal, and FIG. 5 is a table giving a parameter list of recording pulses during recording.

The system controller 21 produces a pulse string for recording, and this is modulated by the modulation circuit 14 into a recording pulse 41 corresponding to a recording clock signal 42. The leading edge of the recording pulse here is termed LM43, the width of the leading pulse is TPW44, and the pulse width of the final edge of the recording pulse is FMW45. The modulated pulse setting circuit 13 sets the recording pulse by setting values according to the recording parameter list shown in FIG. 5.

The recording parameter list in FIG. 5 is an example of the settings for LM43, TPW44, and FMW45 with respect to various recording marks (recording mark lengths 2T to 5T). In FIG. 5, the position where the phase error is zero is used as the reference position, and cases when the values of the recording modulated pulse are set so as to match this reference position are shown as a value of 0. The setting is negative (such as −1) when the value is ahead of this reference position, and positive (such as 1) when the value is behind. If we let T be the reference clock length, the pulse settings are generally between 1/16T and 1/64T according to the characteristics of the disk.

Also, there are three pulse settings (LM, TPW, and FMW) in the present invention, but other settings are also possible, as long as the parameters can be set variably to allow the adjustment of the recording modulated pulse.

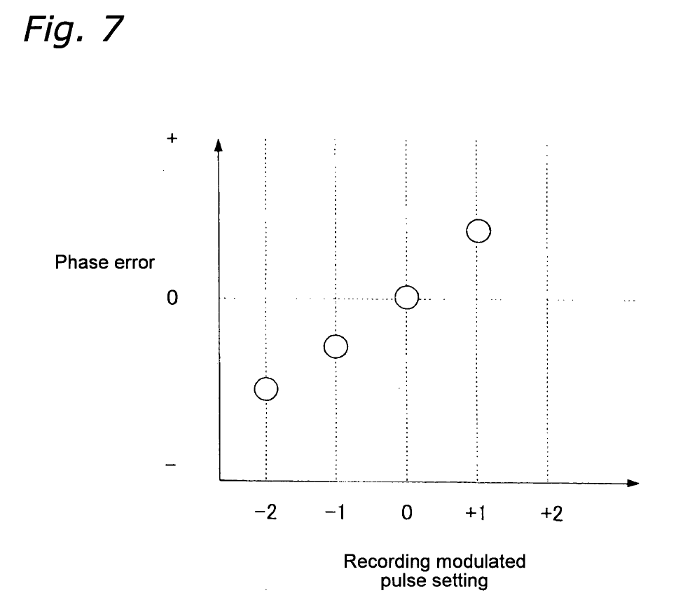

Next, the recording regions used for adjusting the recording modulated pulse, and the results obtained from the recording region will be described through reference to FIGS. 6 and 7.

FIG. 6 is a schematic diagram of the recording region for adjusting the recording modulated pulse. To adjust the recording modulated pulse conditions, recording is performed in a plurality of regions under various conditions in which the recording parameters in FIG. 5 are varied, information is reproduced from the plurality of recorded regions, and the recording modulated pulse conditions are adjusted. For example, if the LM43 edge of a recording mark with a recording mark length of 2T is to be adjusted, LM43 is set to a value of −2 and recording is performed in a recording region 61, LM43 is set to a value of −1 and recording is performed in a recording region 62, LM43 is set to a value of 1 and recording is performed in a recording region 63, and LM43 is set to a value of +1 and recording is performed in a recording region 64. These regions are then reproduced to acquire phase error information.

FIG. 7 is a graph of the phase error difference detection result in the reproduction of the recording regions 61 to 64 for adjusting the recording modulated pulse.

The recording modulated pulse setting is shown on the horizontal axis, and the phase error on the vertical axis. If the recording modulated pulse setting is negative, the recorded mark is smaller, and the phase error signal has a negative output. Conversely, if the recording modulated pulse setting is positive, the recorded mark is larger, and the phase error signal is also outputted larger. For instance, when the result is as shown in FIG. 7, the phase error is 0 when the recording pulse setting is 0, so the recording modulated pulse is set to a value of 0. Specifically, the value of the recording modulated pulse is set so that the absolute value of the phase error signal will be smaller.

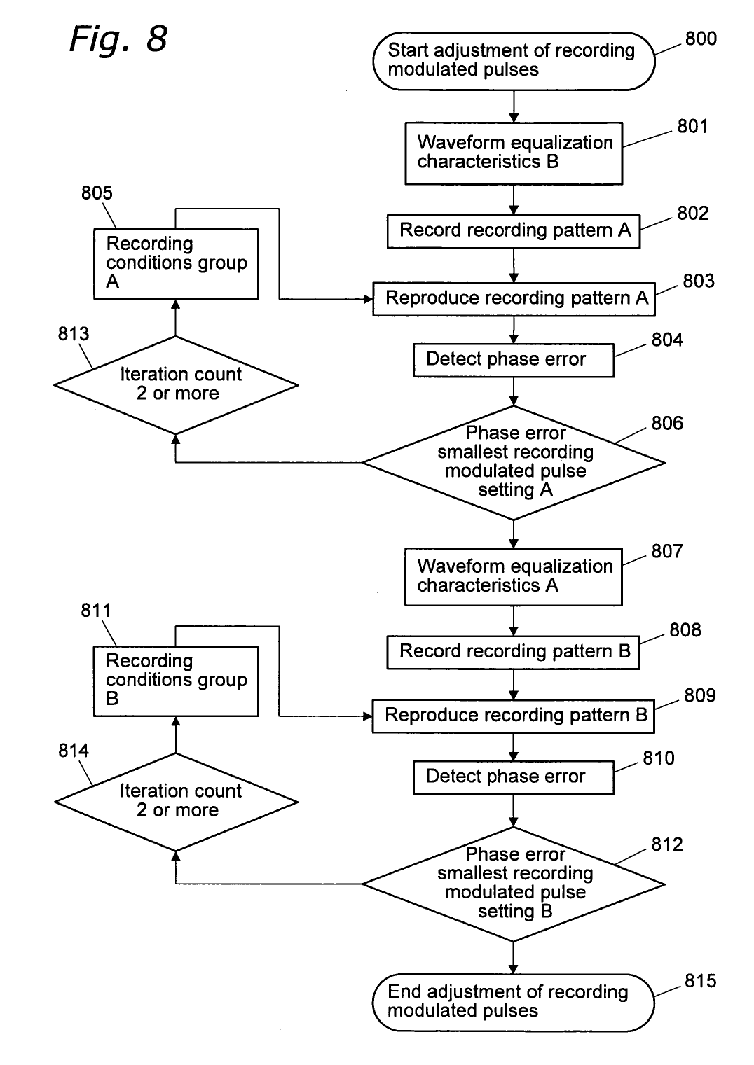

The method of the present invention for adjusting a recording pulse will now be described through reference to FIG. 8.

FIG. 8 is a flowchart of a recording modulated pulse adjustment method using two different recording patterns.

At the start of the adjustment of the recording modulated pulse (800), the recording modulated pulse is initialized. The initial setting may be information placed on the disk ahead of time, or it may be held in the device ahead of time. Next, the waveform equalization characteristics are set to the characteristics B shown in FIG. 9 (801). These characteristics B are parameters stored in the system controller 21 ahead of time, and are waveform equalization characteristics that have been set according to a recording pattern A discussed below. Then, the recording pattern A is recorded to a region of the optical disk 10 where recording is permitted (such as the recording regions 61 to 64 in FIG. 6) (802). The recording pattern A here is a mark group that includes recording marks of recording mark lengths 3T, 4T, and 5T, that is, a mark group that does not include a recording mark of 2T, which is the shortest mark. Next, the region in which the recording pattern A was recorded is reproduced (803), and phase error information for the front and rear edges of each recording mark is detected (804). Then, as shown in FIG. 7, recording modulated pulse setting conditions A are found under which the phase error for each recording mark will be smaller (806).

In particular, the recording modulated pulse setting conditions are adjusted on the basis of the phase error detection information for recording marks of 3T, which are the shortest marks in the recording pattern A. More specifically, when the phase error is large, the recording modulated pulse setting conditions are varied even outside of the initial setting change range (805), the recording pattern A is recorded again (802), and phase error detection is performed (804).

Once the above operation has been repeated a specific number of times (such as two or more) (813), or once the phase error is within a specific range, the flow proceeds to the next step (807). At this point the recording modulated pulse setting conditions have been found for the recording marks of 3T, 4T, and 5T.

Next, the waveform equalization characteristics are set so as to be the characteristics A shown in FIG. 9 (807). These characteristics also are parameters that have been stored in the system controller 21 or the like ahead of time, and are waveform equalization characteristics that are set corresponding to a recording pattern B discussed below. Then, the recording pattern is changed and the recording pattern B is recorded (808). The recording pattern B is a mark group that includes 2T, which is a recording mark that is shorter than those in the recording pattern A. Specifically, the recording pattern B is a mark group made up of recording marks with recording mark lengths of 2T, 3T, 4T, and 5T, that is, a mark group that includes a recording mark of 2T, which is the shortest mark.

Next, the region in which the recording pattern B was recorded (such as the recording regions 61 to 64 in FIG. 6) is reproduced (809), and phase error information for the front and rear edges of each recording mark is detected (810). Then, as shown in FIG. 7, recording modulated pulse setting conditions B are found under which the phase error for each recording mark will be smaller (812).

In particular, the recording modulated pulse setting conditions are adjusted on the basis of the phase error detection information for recording marks of 2T, which are the shortest marks in the recording pattern B. More specifically, when the phase error is large, the recording modulated pulse setting conditions are varied even outside of the initial setting change range (811), the recording pattern B is recorded again (808), and phase error detection is performed (810).

Once the above operation has been repeated a specific number of times (such as two or more) (814), or once the phase error is within a specific range, the examination of recording conditions is complete (815). At this point recording modulated pulse setting conditions have been found for 2T.

As a result of the above operation, the recording modulated pulse setting conditions are found for all recording marks, and the optical disk device can use the recording modulated pulse setting conditions thus found to perform the proper recording operation.

In the setting of recording modulated pulses of 6T or higher, the setting may be performed using predetermined initial settings, or the setting may be performed by another adjustment method prior to the implementation of this embodiment. The present invention is not limited by this.

Also, recording marks of no greater than 5T were used as the recording pattern in this embodiment, but it is also possible to use a recording pattern that includes recording marks of greater than 5T.

The reason for performing the adjustment separately for 2T recording marks and 3T recording marks will now be explained.

With the adjustment of recording modulated pulse setting conditions described in this embodiment, the recording of a specific recording pattern is performed, and the region where recording was performed is reproduced to confirm the length and position of the recorded recording marks.

The reproduction procedure for detecting the length and position of the recording marks here is shown in FIG. 2, and comprises the optical head 11, the pre-amplifier 15, the waveform equalization circuit 16, the binarization circuit 18, and the phase error detection circuit 20. In particular, the length and position of the recording marks is calculated from the phase error detected at the beginning and end of each mark by the phase error detection circuit 20. Accordingly, the amount of phase error detected by the phase error detection circuit 20 will vary with the characteristics of the waveform equalization circuit 16, which is ahead of the phase error detection circuit 20. More specifically, depending on the waveform equalization characteristics, the slice reference level of the waveform detected by the PLL circuit 19 (generally the level near the center of the waveform level) will be detected differently, as will the positions of the beginning and end of each mark. Accordingly, variance of waveform equalization characteristics will let lead to the detection of recording marks with different lengths which are recorded under the same recording conditions. Specifically, to perform the desired recording, the waveform equalization characteristics must be properly set.

Also, with recording marks that record user data, there are recording marks with seven different recording mark lengths from 2T to 8T, for example, but the shorter is the recording mark length, the higher is the probability of occurrence. Consequently, whether a recording state is good or bad is greatly affected by the recording state of the 2T and 3T recording marks, which have the shorter recording mark lengths.

Further, the setting of the waveform equalization characteristics for proper recording is different for 2T and 3T recording marks. For instance, a 2T recording mark is formed smaller than a 3T recording mark, which means that the waveform equalization characteristics for 2T recording marks tend to have the gain of a specific frequency set higher than do the waveform equalization characteristics for 3T recording marks. In view of this, if the length of 3T recording marks is detected in the setting of waveform equalization characteristics for 2T recording marks, the detection result will end up being longer than the desired recording mark length. Consequently, if the recording conditions of 3T recording marks are adjusted using these waveform equalization characteristics, the recording conditions will be adjusted in the direction in which the 3T recording marks become shorter, and the 3T recording marks that are ultimately formed will be shorter than the desired recording mark length, and recording characteristics will deteriorate. On the other hand, if the length of 2T recording marks is detected in the setting of waveform equalization characteristics for 3T recording marks, the detection result will end up being shorter than the desired recording mark length. Consequently, if the recording conditions of 2T recording marks are adjusted using these waveform equalization characteristics, the recording conditions will be adjusted in the direction in which the 2T recording marks become longer, and the 2T recording marks that are ultimately formed will be longer than the desired recording mark length, and recording characteristics will deteriorate.

As described above, in the adjustment of recording conditions for recording marks of different waveform equalization characteristics, the position and length of each recording mark are detected by phase error, so it is difficult to simultaneously adjust recording conditions for the various recording marks in a state in which a single set of waveform equalization characteristics has been set. Also, as mentioned above, the recording state of 2T and 3T recording marks greatly affects the recording quality, and in view of this, with the present invention, the desired recording can be performed by adjusting the recording conditions separately for 2T and 3T recording marks.

Let us here describe the recording patterns used in the adjustment of the various recording marks.

The recording patterns used for adjusting the recording modulated pulse conditions do not need to be user data patterns. Any recording pattern that is convenient for adjustment can be used as the recording pattern. For example, if user data is used in the adjustment of 2T recording marks, because 2T recording marks have a higher probability of occurring, a change in the recording state of 2T recording marks will sharply and adversely affect recording characteristics, so that it may be impossible for the above-mentioned phase error detection to be carried out properly. In view of this, a recording pattern is used in which the probability of occurrence of the various recording mark lengths is made uniform. With a recording pattern such as this, the effect that changes in the recording state of 2T recording marks have on recording characteristics is not as great as when user data is used, the above-mentioned phase error detection can be carried out properly, and the recording modulated pulse conditions can be suitably adjusted.

Also, a recording pattern may be used that is different during the adjustment of recording conditions for 2T recording marks and during the adjustment of recording conditions for 3T recording marks. With this embodiment, a recording pattern that does not include 2T recording marks is used to eliminate the effect of 2T recording marks during the adjustment of 3T recording marks. The effect of the 2T recording marks here is as follows. If unadjusted 2T recording marks are included, the slice reference level of the PLL circuit 19 described above will deviate from the desired level, and the length and position of the 3T recording marks will not be properly detected. With this embodiment, the adjustment of 2T recording marks is performed after the adjustment of 3T recording marks. Therefore, the 3T recording marks are already properly adjusted during the adjustment of the 2T recording marks. Thus, during the adjustment of 2T recording marks, a recording pattern that includes 3T recording marks can be used. The order in which the 2T recording marks and 3T recording marks are adjusted may also be reversed.

The apparatus described in this embodiment may be realized by an integrated circuit or the like. More specifically, in the optical disk device described through reference to FIG. 2 in the above embodiment, each block may be made into an individual chip by means of an LSI chip or other such semiconductor device, or a single chip may include some or all of the components.

More specifically, in FIG. 2, the optical disk 10, the optical head 11, the laser drive circuit 12, the pre-amplifier 15, the blocks other than the motor 22 (the modulated pulse setting circuit 13, the modulation circuit 14, the waveform equalization circuit 16, the binarization circuit 18, the phase error detection circuit 20, the PLL circuit 19, and the system controller 21) may be individually made into a chip, or a single chip may include some or all of the components.

An LSI chip was mentioned here, but depending on the degree of integration, this may also be called an IC, system LSI chip, super-LSI chip, or ultra-LSI chip.

The creation of an integrated circuit is not limited to LSI, and may instead be accomplished by a dedicated circuit or a multipurpose processor. After the manufacture of an LSI chip, a FPGA (Field Programmable Gate Array) that can be programmed, or a reconfigurable processor in which the connections or settings of the circuit cells inside the LSI chip can be reconfigured, may be utilized.

Furthermore, if some technology for circuit integration that supplants LSI should make its debut, either through an advance in semiconductor technology or a separate derivative technology, then of course that technology may be used to integrate the function blocks. It is also conceivable that biotechnology or the like would be applicable.

Adjusting the recording modulated pulse conditions as above allows an information recording and reproduction apparatus to perform more uniform recording to an optical disk device, and ensures the reliability and interchangeability of a device.

### INDUSTRIAL APPLICABILITY

The recording condition optimization method, information recording and reproduction method, information recording and reproduction apparatus, and integrated circuit pertaining to the present invention are useful, for example, in optical disk devices that record and reproduce information to and from high-density optical disks such as DVDs and BDs.

1. A method for optimizing a recording condition in recording of information to an optical disk, comprising:
a recording step of recording a recording pattern including a plurality of recording marks to the optical disk using a specific recording condition;
a reproduction step of reproducing the recording pattern recorded in the recording step;
an equalization characteristics setting step of setting waveform equalization characteristics according to the recording pattern;
an equalization step of using the waveform equalization characteristics set in the equalization characteristics setting step to equalize a waveform of a reproduction signal reproduced in the reproduction step; and
an adjustment step of using the reproduction signal whose waveform has been equalized in the equalization step to adjust the recording condition.

2. The method for optimizing a recording condition according to claim 1,
wherein the recording condition is a condition pertaining to modulated pulses in the recording of information to the optical disk.

3. The method for optimizing a recording condition according to claim 2,
wherein a position of the modulated pulse is adjusted in the adjustment step.

4. The method for optimizing a recording condition according to claim 1,
wherein at least one recording pattern does not include a shortest mark.

5. The method for optimizing a recording condition to claim 1,
wherein at least one recording pattern includes a shortest mark.

6. The method for optimizing a recording condition according to claim 1,
wherein a high-band gain of the waveform equalization characteristics in the reproduction of the recording pattern including no shortest mark is lower than a high-band gain of the waveform equalization characteristics in the reproduction of the recording pattern including a shortest mark.

7. The method for optimizing a recording condition according to claim 1,
wherein the recording marks in the recording pattern are generated substantially uniformly.

8. The method for optimizing a recording condition according to claim 1
wherein the waveform equalization characteristics are characteristics determined by reproducing a portion where a desired signal has been recorded or formed on the disk ahead of time.

9. The method for optimizing a recording condition according to claim 1,
wherein the adjustment step includes a step of detecting phase error information of the reproduction signal, and modulated pulses are adjusted on the basis of the phase error information so that the phase error information becomes smaller overall.

10. An apparatus for recording and reproducing information to and from an optical disk using a light source such as a laser, comprising:
a recording unit for recording a recording pattern including a plurality of recording marks to the optical disk using a specific recording condition;
a reproduction unit for reproducing the recording pattern recorded by the recording unit;
an equalization characteristics setting unit for setting waveform equalization characteristics according to the recording pattern;
an equalization unit for using the waveform equalization characteristics set by the equalization characteristics setting unit to equalize a waveform of a reproduction signal reproduced in the reproduction unit; and
an adjustment unit for using the reproduction signal whose waveform has been equalized in the equalization unit to adjust the recording condition.

11. The apparatus for recording and reproducing information according to claim 10,
wherein the equalization characteristics setting unit varies the waveform equalization characteristics on the basis of characteristics determined by reproducing a portion where a desired signal has been recorded or formed on the disk ahead of time.

12. The apparatus for recording and reproducing information according to claim 10, wherein a gain of the waveform equalization characteristics in the reproduction of the recording pattern that does not include a shortest mark is lower than a gain of the waveform equalization characteristics in the reproduction of the recording pattern that includes a shortest mark.

13. An integrated circuit apparatus for optimizing a recording condition in recording of information to an optical disk, comprising:
an equalization characteristics setting component for setting waveform equalization characteristics according to a recording pattern that is recorded to the optical disk using a specific recording condition and includes a plurality of recording marks; and
an adjustment component for adjusting the recording condition by using a signal obtained by equalizing, with the waveform equalization characteristics, a waveform of a reproduction signal obtained by reproducing the recording pattern recorded to the optical disk.

14. A program for optimizing a recording condition in recording of information to an optical disk, comprising:
an equalization characteristics setting step of setting waveform equalization characteristics according to a recording pattern that is recorded to the optical disk using a specific recording condition and includes a plurality of recording marks; and
an adjustment step of adjusting the recording condition by using a signal obtained by equalizing, with the waveform equalization characteristics, a waveform of a reproduction signal obtained by reproducing the recording pattern recorded to the optical disk.
